(19) United States
(12) Patent Application Publication
(10) Pub. No.: US 2008/0044586 A1
(43) Pub. Date: Feb. 21, 2008

(54) Integrated Dual-Cure Coating Material System and Use Thereof for the Internal and External Coating of Complex Shaped Three-Dimensional Substrates

(75) Inventors: Hubert Baumgart, Munster (DE); Thomas Semmelmann, Regensburg (DE); Maria Wehner, Dettelbach (DE)

Correspondence Address: BASF CORPORATION;Patent Department, 1609 BIDDLE AVENUE, MAIN BUILDING, WYANDOTTE, MI, 48192, US

(73) Assignee: BASF COATINGS AG, MUNSTER (DE)

(21) Appl. No.: 11/569,225

(22) PCT Filed: May 19, 2005
(86) PCT No.: PCT/EP05/52385

§ 371 Date: Nov. 16, 2006

(30) Foreign Application Priority Data
May 29, 2004 (DE) 10 2004 023 423.6

(51) Int. Cl. B05D 3/06; C08F 120/10

(52) U.S. Cl. 427/487; 106/287.25

(57) ABSTRACT

An integrated dual-cure coating material system which comprises two dual-cure multicomponent systems (A) and (B) which are composed predominantly or wholly of the same constituents and comprise in each case two components stored separately from one another,

(I) one component containing
(i.1) isocyanate-reactive functional groups and
(i.2) reactive functional groups containing at least one bond which can be activated with actinic radiation,
(i.3) flexibilizing structural units which as parts of three-dimensional networks lower their glass transition temperature Tg, and/or
(i.4) hardening structural units which as part of three-dimensional networks raise their glass transition temperature Tg and

(I1) one component containing
(ii.1) free isocyanate groups,
(ii.2) reactive functional groups containing at least one bond which can be activated with actinic radiation and
(ii.3) flexibilizing structural units which as parts of three-dimensional networks lower their glass transition temperature Tg, and/or
(ii.4) hardening structural units which as part of three-dimensional networks raise their glass transition temperature Tg, the dual-cure coating material system (B) having
(a) overall a lower quantity of reactive functional groups containing bonds which can be activated with actinic radiation, and/or
(b) overall a higher quantity of hardening structural units which as part of three-dimensional networks raise their glass transition temperature Tg,
   than the dual-cure coating material system (A); and its use.

The present invention relates to a new integrated dual-cure coating material system. The present invention also relates to the use of the new integrated dual-cure coating material system for the internal and external coating of three-dimensional substrates of complex shape. The present invention further relates to a new process for the internal and external coating of three-dimensional substrates of complex shape with dual-cure coating materials. The present invention relates not least to three-dimensional substrates of complex shape coated internally and externally using the new integrated dual-cure coating material system.

The high-quality coating or painting of three-dimensional substrates of complex shape such as motor vehicle bodies, especially automobile bodies, is naturally complex and raises numerous technical problems. Thus the color and/or effect paint systems of motor vehicle bodies, particularly automobile bodies, nowadays consist preferably of a plurality of paint coats which are applied atop one another and have different properties.

For example an electrodeposition coat (electrocoat) primer, a primer-surfacer coat or antistonechip primer coat, a basecoat and a clearcoat are applied successively onto a substrate. In this system the electrocoat serves in particular to protect the sheet metal against corrosion. By those skilled in the art it is often also referred to as the primer. The primer-surfacer coat serves to cover unevennesses in the substrate and because of its elasticity it imparts stonechip resistance. The primer-surfacer coat may also serve to reinforce the hiding power and to deepen the shade of the paint system. The basecoat contributes the colors and/or optical effects. The clearcoat is used to intensify the optical effects and to protect the paint system against mechanical and chemical damage. Basecoat and clearcoat are frequently also referred to collectively as the topcoat. For further details refer to Römpp Lexikon Lacke und Druckfarben, Georg Thieme Verlag, Stuttgart, New York, 1998, pages 49 and 51, “Automotive finishes”. In the text below, these multicoat paint systems are referred to as multicoat color and/or effect paint systems.

More recently the clearcoats in particular have been produced from clearcoat materials which are curable thermally and with actinic radiation. Actinic radiation here and below means electromagnetic radiation, such as near infrared, visible light, UV radiation or X-rays or gamma radiation, especially UV radiation, and corpuscular radiation, such as electron beams, proton beams, alpha radiation, beta radiation or neutron beams, especially electron beams. Combined curing by means of heat and actinic radiation is also referred to by those skilled in the art as dual cure.

Dual-cure coating materials, especially dual-cure clearcoat materials, possess the key advantage that, even in the shadow zones of three-dimensional substrates of complex shape, such as autobodies, radiators or electrical wound articles, and even in the absence of optimum—in particular, complete—exposure of the shadow zones to actinic radiation, they provide coatings whose profile of performance properties comes close to that of the coatings outside of the shadow zones. As a result the coatings in the shadow zones are also no longer so readily damaged by mechanical and/or chemical attack, as may occur, for example, on the production line during the installation of further motor vehicle components into the coated bodies.

Moreover curing with actinic radiation may compensate incomplete thermal curing, if for example the dual-cure coating materials cannot be heated to the temperatures required for rapid progression of the thermal crosslinking reactions, owing to the temperature sensitivity of the coated substrates.

Dual-cure coating materials and their use for producing high-quality multicoat color and/or effect paint systems are known for example from patent applications DE 42 15 070 A1, DE 198 18 735 A 1, DE 199 08 018 A 1, DE 199 30 665 A 1, DE 199 30 067 A 1, DE 199 30 664 A 1, DE 199 24 674 A 1, DE 199 20 799 A 1, DE 199 58 726 A 1, DE 199 61 926 A 1, DE 100 42 152 A 1, DE 100 47 989 A1 DE 100 55 549 A 1, DE 101 29 970 A 1, DE 102 02 565 A 1, DE 102 04 114 A 1, EP 0 928 800 A 1 or EP 0 952 170 A 1 or from patent DE 101 29 660 C 1.

In spite of all the advantages the dual-cure coating materials doubtless offer, the coating or painting of the very complexly shaped automobile bodies is still accompanied again and again in practice by problems. Thus frequently the radiation of shadow zones sufficiently in the sense referred to above—for example, beneath the trunk lid and the engine hood and in the region of the doorsills, the trunk and the insides of the doors and windows, even if the doors, lids and hoods are kept wide open, is not possible to the desired extent. An adequate profile of performance properties must therefore be brought about (forcibly) in the shadow zones by way of thermal crosslinking, which can, however, lead to problems, especially if the painting operation is intended to embrace surface-mounted bodywork components which are made of plastic and must not be exposed to high temperatures. In other words the problem arises that the thermal crosslinking is unable to compensate the deficiencies of inadequate radiation curing to the extent required.

One possible solution to this problem is to use a special coating material for the interior (internal coating material) which is particularly reactive in the sense of thermal crosslinking. Highly reactive coating materials of this kind have been known for a long time and normally comprise binders containing isocyanate-reactive groups and, as crosslinking agents, polyisocyanates (two-component systems). By means of such materials it would be possible for the profile of performance properties of the coating in the shadow zones to match the profile of performance properties of the coating in the areas which have been cured with a sufficient radiation dose and thermally cured.

It has proven to be the case, however, that then, in those regions of the bodies in which internal coating material and external coating material (that is, the coating material for the external area) overlap, severe paint defects occur. These defects come about in particular through incompatibility between internal and external coating materials when applied wet on wet. The effect of this incompatibility is that the spray mist of the one coating material cannot be absorbed by the wet film of the other coating material.

It is therefore an object of the present invention to provide a new integrated dual-cure coating material system which no longer has the disadvantages of the prior art but which instead allows the coating of three-dimensional substrates of complex shape, especially motor vehicle bodies, specifically automobile bodies, internally and externally without problems and which provides a coating which even internally has a profile of performance properties which at least matches that of the profile of performance properties of the coating externally which it has been possible to cure with a sufficient radiation dose. The intention is that, in those areas in which the coating of the interior (internal coating) merges into the coating of the exterior (external coating), there should no longer be any defects in the coating (paint defects).

The invention accordingly provides the new integrated dual-cure coating material system which comprises at least two dual-cure multicomponent systems (A) and (B) which are composed predominantly or wholly of the same constituents and comprise in each case at least two components stored separately from one another,

(I) at least one component containing
(i.1) isocyanate-reactive functional groups and
(i.2) reactive functional groups containing at least one bond which can be activated with actinic radiation,
(i.3) flexibilizing structural units which as parts of three-dimensional networks lower their glass transition temperature Tg, and/or
(i.4) hardening structural units which as part of three-dimensional networks raise their glass transition temperature Tg
and

(II) at least one component containing
(ii.1) free isocyanate groups,
(ii.2) reactive functional groups containing at least one bond which can be activated with actinic radiation and
(ii.3) flexibilizing structural units which as parts of three-dimensional networks lower their glass transition temperature Tg, and/or
(ii.4) hardening structural units which as part of three-dimensional networks raise their glass transition temperature Tg,
   the dual-cure coating material system (B) having
(a) overall a lower quantity of reactive functional groups containing at least one bond which can be activated with actinic radiation, and/or
(b) overall a higher quantity of hardening structural units which as part of three-dimensional networks raise their glass transition temperature Tg,
   than the dual-cure coating material system (A).

The new integrated dual-cure coating material system is referred to below as “system of the invention”.

The invention further provides for the new use of the system of the invention for the internal and external coating of three-dimensional substrates of complex shape, this being referred to below as “use in accordance with the invention”.

The invention further provides the new process for the internal and external coating of three-dimensional substrates of complex shape which embraces the use in accordance with the invention and comprises
(1) preparing in each case at least one dual-cure coating material (A) and (B) from in each case at least one dual-cure multicomponent system (A) and (B) by mixing in each case at least one component (1) and (11) and homogenizing the resulting mixture, and
(2) coating the outside of the three-dimensional substrate with the dual-cure coating material (A) and the inside of the three-dimensional substrate with the dual-cure coating material (B), and then
(3) curing the resulting coatings thermally and with actinic radiation to give the internal and external coating.

The new process for the internal and external coating of three-dimensional substrates of complex shape is referred to below as “process of the invention”.

Additional subject matter of the invention will emerge upon reading the description.

In the light of the prior art it was surprising and unforeseeable for the skilled worker that the object on which the present invention was based could be achieved by means of the system of the invention, the use in accordance with the invention and the process of the invention, respectively.

In particular it was surprising that the system of the invention no longer had the disadvantages of the prior art but instead, in the context of the use in accordance with the invention, allowed the coating of three-dimensional substrates of complex shape, particularly motor vehicle bodies, especially automobile bodies, internally and externally in accordance with the process of the invention, without problems, and gave coatings which even internally have a profile of performance properties which at least matched the profile of performance properties of the coatings externally which it was possible to cure with a sufficient radiation dose. In the areas in which the coatings of the interior (internal coating) merged into that of the exterior (external coating) there were no longer any defects in the coatings (paint defects).

The system of the invention comprises at least two, especially two, dual-cure multicomponent systems (A) and (B), in particular dual-cure two-component systems (A) and (B).

The dual-cure multicomponent systems (A) and (B) are composed predominantly or wholly of the same constituents. “Predominantly” here means that the dual-cure multicomponent systems (A) and (B) differ in not more than three and preferably in not more than two constituents and in particular in only one constituent from one another.

Each of the dual-cure multicomponent systems (A) and (B) comprises at least two, especially two, components (I) and (II) which are stored separately from one another until the dual-cure coating materials (A) and (B) are prepared in the context of the use in accordance with the invention.

In each dual-cure multicomponent system (A) and (B) the at least one, especially one, component (I) contains isocyanate-reactive functional groups (i.1) which are selected preferably from the group consisting of hydroxyl groups, thiol groups and primary and secondary amino groups, especially hydroxyl groups.

It additionally contains reactive functional groups (i.2) which contain at least one, especially one, bond which can be activated with actinic radiation. Examples of suitable bonds which can be activated with actinic radiation and of reactive functional groups (i.2) which comprise them are known from German patent application DE 101 29 970 A 1, page 8 paragraphs [0059] to [0061]. Acrylate groups (i.2) in particular are used.

They further comprise flexibilizing structural units (i.3) which as parts of three-dimensional networks lower their glass transition temperature Tg. Examples of suitable flexibilizing structural units (i.3) are likewise known from German patent application DE 101 29 970 A 1, page 8 paragraph [0064] to page 9 paragraph [0072].

Not least they comprise hardening structural units (i.4) which as part of three-dimensional network raise their glass transition temperature Tg. Examples of suitable hardening structural units (i.4) are likewise known from German patent application DE 101 29 970 A 1, page 9 paragraph [0079] to page 10 paragraph [0085].

The “three-dimensional networks” are present in the thermoset solids of the coatings or paint systems (A) and (B) produced from the dual-cure multicomponent systems (A) and (B) and form the major constituent or the sole constituent of these coatings or paint systems (A) and (B). The glass transition temperatures Tg of the coatings or paint systems (A) and (B) are therefore particularly determined by the physical composition and structure of the three-dimensional networks. The physical composition and the structure of the three-dimensional networks in turn are adjusted via the selection of the constituents of the dual-cure multicomponent systems (A) and (B).

Preferably component (I) comprises at least one polymeric and/or oligomeric binder; in particular it comprises two oligomeric and/or polymeric binders, some or all of the isocyanate-reactive functional groups (i.1) being present in the binder or binders.

The binders may contain reactive functional groups (i.2). Preferably, however, they are free of these groups.

The binder consists of or comprises structural units (i.3) and (i.4). The structural units (i.3) and (i.4) are used in a ratio such that the binders, following their incorporation into the three-dimensional networks, contribute to setting the desired glass transition temperature Tg.

Examples of suitable binders and the amounts in which they are preferably used in components (I) are known from German patent application DE 101 29 970 A 1, page 3 paragraph [0018] to page 6 paragraph [0041]. Use is made in particular of (meth)acrylate copolymers. Preferably these have a glass transition temperature of from −50 to +110° C., preferably from −30 to +80° C., more preferably from −15 to +70° C., very preferably from −15 to +50° C., with very particular preference from −15 to +40° C. and in particular from −15 to +30° C. Their acid number is guided in particular by whether they are to be used in aqueous coating materials of the invention; preferably the acid number is from 5 to 100 mg KOH/g. Similarly the amount of isocyanate-reactive groups they contain, hydroxyl groups in particular, may vary widely; preferably their hydroxyl number is from 20 to 300, more preferably from 30 to 250, very preferably from 40 to 200, with very particular preference from 60 to 190 and in particular from 80 to 180 mg KOH/g.

Component (I) preferably comprises at least one, in particular one, low molecular mass and/or oligomeric constituent which contains at least one reactive functional group (i.2) and preferably at least two, more preferably at least three and in particular at least four reactive functional groups (i.2). This constituent may further contain at least one, in particular one, isocyanate-reactive functional group (i.1). Preferably the predominant proportion or all of the reactive functional groups (i.2) of component (I) are present in this constituent. Examples of suitable constituents of this kind and the amounts in which they are preferably used in components (I) are known from German patent application DE 101 29 970 A 1, page 11 paragraphs [0101] to [0103].

Component (I) may further comprise conventional coatings additives such as are described, for example, in German patent application DE 101 29 970 A 1, page 12 paragraph [0123]. Use is made in particular of pseudoplastic sag control agents (SCAs).

Component (I) may additionally comprise conventional pigments such as are described, for example, in German patent application DE 101 29 970 A 1, page 11 paragraph [0104] to page 12 paragraph [0121]. Use is made in particular of nanoparticles.

The preparation of component (I) has no special features as far as its method is concerned but instead takes place by mixing of the above-described constituents and mixing and homogenizing of the resulting mixtures by means of conventional mixing techniques and apparatus such as stirred tanks, agitator mills, extruders, kneading apparatus, Ultraturrax, inline dissolvers, static mixers, toothed wheel dispersers, pressure release nozzles and/or microfluidizers, preferably in the absence of actinic radiation.

For each dual-cure multicomponent system (A) and (B) the at least one, in particular one, component (II) contains free isocyanate groups (ii.1). It may additionally to a minor extent contain blocked isocyanate groups as well, as described for example in German patent application DE 101 29 970 A 1 in the paragraph [0058] bridging pages 7 and 8.

Component (II) further contains reactive functional groups (ii.2) containing at least one bond which can be activated with actinic radiation. Examples of suitable reactive functional groups (ii.2) are the reactive functional groups (i.2) described above.

Component (II) further comprises flexibilizing structural units (ii.3) which as part of three-dimensional networks lower their glass transition temperature Tg. Examples of suitable flexibilizing structural units (ii.3) are the above-described structural units (i.3).

Component (II) not least comprises hardening structural units (ii.4) which as part of three-dimensional networks raise their glass transition temperature Tg. Examples of suitable hardening structural units (ii.4) are the structural units (i.4) described above.

Component (II) preferably consists of or comprises at least one constituent which mandatorily exhibits features (ii.1) and (ii.2).

Examples of suitable components (II) and of suitable constituents of features (ii.1) and (ii.2), processes for preparing them and the amounts in which they can preferably be used in the dual-cure multicomponent systems (A) and (B) are known in detail from German patent application DE 101 29 970 A 1, page 6 paragraph [0042] to page 11 paragraph [0100].

Component (II) may further comprise the above-described coatings additives provided they do not react with isocyanate groups (ii. 1) under the conditions in which component (II) is prepared, stored and used.

The preparation of component (II) likewise requires no special features as far as its method is concerned; instead the above-described apparatus and techniques can be used.

For the system of the invention it is essential that the dual-cure coating material system (B) has overall a lower level of reactive functional groups (i.2)+(ii.2) and/or overall a higher level of hardening structural units (i.4)+(ii.4) than the dual-cure coating material system (A).

The system of the invention serves for internally and externally coating three-dimensional substrates of complex shape. Examples of three-dimensional substrates of complex shape are bodies of means of transport, including means of transport operated by engine power and/or muscle power, such as automobiles, commercial vehicles, buses, motor cycles, cycles, rail vehicles, watercraft and aircraft, and parts thereof, constructions and parts thereof, doors, windows, furniture, and mechanical, optical and electronic components. The system of the invention serves in particular for internally and externally coating both motor vehicle bodies, especially automobile bodies.

In the context of the use in accordance with the invention the dual-cure coating materials (A) and (B) are prepared from the dual-cure coating material systems (A) and (B) by mixing the above-described components (I) and (II) and homogenizing the resulting mixtures.

The resulting dual-cure coating materials (A) and (B) are preferably conventional coating materials, containing organic solvents, aqueous coating materials or substantially or completely solvent-free and water-free liquid coating materials (100% systems).

They can be used for producing hiding coatings or paint systems, such as primer-surfacer coats, basecoats and solid-color topcoats. In particular they are outstandingly suitable for producing transparent single-coat and multicoat clearcoat systems, and also clearcoats of multicoat, color and/or effect, electrically conductive, magnetically shielding and/or fluorescent coatings, in particular by the wet-on-wet method, in which case a basecoat material, in particular an aqueous basecoat material, is applied to the surface of the substrate and then the resulting basecoat film is dried without being cured and is overcoated with a clearcoat film. Thereafter the two films are jointly cured.

In terms of method the application of the dual-cure coating materials (A) and (B) have no special features but may instead take place by any customary application method, such as spraying, knife coating, brushing, flow coating, dipping, trickling or rolling, for example. Preference is given to employing spray application methods. It is generally advisable to operate in the absence of actinic radiation in order to prevent premature crosslinking of the coating materials, adhesives and sealants of the invention.

In this context it is preferred to employ the process of the invention. In other words the outside or areas of the outside of the three-dimensional substrate are coated with the dual-cure coating material (A) and the inside or areas of the inside of the three-dimensional substrate are coated with the dual-cure coating material (B). Subsequently the resulting uncured coatings (A) and (B), together where appropriate with other uncured coatings present, are cured thermally and with actinic radiation, giving the integrated internal and external coating or integrated internal/external paint system (B/A).

Curing itself has no particular features in terms of method; instead it is possible to carry out curing with the aid of the apparatus and techniques described in German patent application DE 102 02 565 A 1, page 9 paragraph [0090] to page 10 paragraph [0107].

The resulting internal coating or internal paint system (B) of the invention is hard and scratch-resistant and so is no longer damaged when further motor vehicle components are installed or mounted. It has outstanding optical properties and very high light stability and chemical, water, condensation, weathering and etch resistance. Its capacity for overcoating is outstanding.

The resulting external coating (A) of the invention is highly scratch-resistant and hard, and so satisfies all of the requirements imposed by the automakers and their customers. In particular its clearcoat, produced from the dual-cure coating material (A), has a storage modulus E′ in the rubber-elastic range of at least 10^{7.5} Pa and a loss factor tan δ at 20° C. of max. 0.1, the storage modulus E′ and the loss factor having been measured by means of dynamomechanical thermal analysis (DMTA) on free films having a thickness of 40±10 μm (cf. German patent application DE 102 02 565 A 1). It too has outstanding optical properties and very high light stability and chemical, water, condensation, weather and etch resistance. Its capacity for overcoating is outstanding.

Furthermore the integrated internal and external paint system (B/A) of the invention is free from paint defects, such as strips, craters, pots or runs, in the areas where internal paint system (B) and external paint system (A) overlap.

### EXAMPLES

### Example 1

### The Preparation of Integrated Dual-Cure Coating Material Systems

### The Dual-Cure Two-Component Systems (A1) and (A2)

To prepare the integrated dual-cure coating material systems for producing integrated internal and external paint systems (B/A) on automobile bodies first of all the dual-cure two-component systems (A1) and (A2) listed in Table 1 were prepared by mixing the constituents to their components (I) and (II) and homogenizing the resulting mixtures (I) and (II) in the absence of UV radiation. The respective components (I) and (II) were stored separately from one another prior to their use.

TABLE 1
The physical composition of the dual-cure two-
component systems (A1) and (A2)

| Constituent | (A1) | (A2) |
|---|---|---|
| Component (I): | | |
| Methacrylate copolymer (solids: | 39.9 | 39.9 |
| 65% by weight; hydroxyl number: 175 mg KOH/g; | | |
| glass transition temperature: −21° C.) | | |
| Rheological assistant (SCA) based on urea | 17.1 | 17.1 |
| as in Preparation Example 3, page 11 lines | | |
| 41 to 51, DE 102 04 114 A 1 (solids: | | |
| 59% by weight) | | |
| Aerosil ® paste (solids: 28.47% by weight) | 3.3 | 3.3 |
| Dipentaerythrityl pentaacrylate (solids: | 22.8 | 22.8 |
| 100% by weight) | | |
| Tinuvin ® 292 (commercial light stabilizer | 1.1 | 1.1 |
| from Ciba Specialty Chemicals; solids: | | |
| 100% by weight) | | |
| Tinuvin ® 400 (commercial light stabilizer | 1.1 | 1.1 |
| from Ciba Specialty Chemicals; solids: | | |
| 85% by weight) | | |
| Byk ® 358 (commercial coatings additive | 0.9 | 0.9 |
| from Byk Chemie; solids: 52% by weight) | | |
| Irgacure ® 184 (commercial photoinitiator | 2.2 | 2.2 |
| from Ciba Specialty Chemicals; solids: | | |
| 50% by weight) | | |
| Lucirin ® TPO (commercial photoinitiator | 1.1 | 1.1 |
| from BASF Aktiengesellschaft; solids: | | |
| 10% by weight) | | |
| Methoxypropanol | 3 | 3 |
| Butyl diglycol acetate | 2 | 2 |
| Butyl acetate | 5.5 | 5.5 |
| Component (II): | | |
| Isocyanato acrylate Roskydal ® UA VPLS 2337 | 55.02 | 48.1 |
| from Bayer AG (basis: trimeric | | |
| hexamethylene diisocyanate; isocyanate | | |
| equivalent weight: 329 g; solids: | | |
| 100% by weight) | | |
| Isocyanato acrylate Roskydal ® UA VP FWO | 13.77 | 22.3 |
| 3003-77 from Bayer AG based on | | |
| the trimer of isophorone diisocyanate | | |
| (solids: 70.5% by weight; isocyanate | | |
| equivalent weight: 609 g) | | |
| Polyisocyanate based on isophorone diisocyanate | 9.79 | 12.8 |
| (Desmodur ® N 3300 from Bayer AG) | | |
| Butyl acetate 98/100 | 21.42 | 16.8 |

### The Dual-Cure Two-Component Systems (B1) and (B5)

To prepare the integrated dual-cure coating material systems for producing integrated internal and external paint systems (B/A) on automobile bodies first of all the dual-cure two-component systems (B1) to (B5) listed in Table 2 were prepared by mixing the constituents to their components (I) and (II) and homogenizing the resulting mixtures (I) and (II) in the absence of UV radiation. The respective components (I) and (II) were stored separately from one another prior to their use.

TABLE 2
The physical composition of the dual-cure two-
component systems (B1) to (B5)

| | | | | | |
|---|---|---|---|---|---|
| Constituent | (B1) | (B2) | (B3) | (B4) | (B5) |

Component (I):

| | | | | | |
|---|---|---|---|---|---|
| Methacrylate copolymer^{a)} | — | — | 58.7 | — | — |
| Methacrylate copolymer^{b)} | 39.9 | 39.9 | — | 38.7 | 38.7 |
| Rheological assistant (SCA)^{c)} | 17.1 | 17.1 | 17.1 | 16.6 | 16.6 |
| Aerosil ® paste^{d)} | 3.3 | 3.3 | 3.3 | 3.2 | 3.2 |
| Dipentaerythrityl pentaacrylate^{e)} | 22.8 | 22.8 | 4.7 | 22.1 | 221 |
| Tinuvin ® 292^{f)} | 1.1 | 1.1 | 1.1 | 1.1 | 1.1 |
| Tinuvin ® 400^{g)} | 1.1 | 1.1 | 1.1 | 1.1 | 1.1 |
| Byk ® 358^{h)} | 0.9 | 0.9 | 0.9 | 0.9 | 0.9 |
| Irgacure ® 184ⁱ⁾ | 2.2 | 2.2 | 2.2 | 2.1 | 2.1 |
| Lucirin ® TPO^{j)} | 5.5 | 5.5 | 5.5 | 5.3 | 5.3 |
| Methoxypropanol | 3 | 3 | 3 | 2.9 | — |
| Butyl diglycol acetate | 2 | 2 | 2 | 1.9 | 8.9 |
| Butyl acetate | 1.1 | 1.1 | 0.4 | 4.1 | — |

Component (II):

| | | | | | |
|---|---|---|---|---|---|
| Isocyanato acrylate^{k)} | — | 9.2 | 9.2 | 9.2 | 9.2 |
| Isocyanato acrylate^{l)} | 8.3 | 67.9 | 67.9 | 67.9 | 67.9 |
| Polyisocyanate^{m)} | 5.9 | 7.2 | 7.2 | 7.2 | 7.2 |
| Isocyanato acrylateⁿ) | 73 | — | — | — | — |
| Butyl acetate 98/100 | 12.8 | 15.7 | 15.7 | 15.7 | 15.7 |

^{a)}solids: 65% by weight; hydroxyl number: 175 mg KOH/g; glass transition temperature: −21° C.;
^{b)}solids: 65% by weight; hydroxyl number: 175 mg KOH/g; glass transition temperature: +11° C.;
^{c)}urea-based SCA as per Preparation Example 3, page 11 lines 41 to 51, of DE 102 04 114 A 1 (solids: 59% by weight);
^{d)}solids: 28.47% by weight;
^{e)}solids: 100% by weight;
^{f)}commercial light stabilizer from Ciba Specialty Chemicals; solids: 100% by weight;
^{g)}commercial light stabilizer from Ciba Specialty Chemicals; solids: 85% by weight;
^{h)}commercial coatings additive from Byk Chemie; solids: 52% by weight;
ⁱ⁾commercial photoinitiator from Ciba Specialty Chemicals; solids: 50% by weight;
^{j)}commercial photoinitiator from BASF Aktiengesellschaft; solids: 10% by weight;
^{k)}Roskydal ® UA VPLS 2337 from Bayer AG (basis: trimeric hexamethylene diisocyanate; isocyanate group content: 12% by weight; solids: 100% by weight);
^{l)}Roskydal ® UA VP FWO 3003-77 from Bayer AG, based on the trimer of isophorone diisocyanate (solids: 70.5% by weight; isocyanate group content: 6.7% by weight);
^{m)}polyisocyanate based on isophorone diisocyanate (Desmodur ® N 3300 from Bayer AG);
ⁿ)Isocyanato acrylate based on 4,4′-dicyclohexylmethane diisocyanate (Desmodur ® W from Bayer AG) and 4-hydroxybutyl acrylate (solids: 70% by weight; isocyanate equivalent weight 724 g).

### The Integrated Dual-Cure Coating Material Systems

Each of the above-described dual-cure multicomponent systems (A1) or (A2) was combinable with each of the above-described dual-cure multicomponent systems (B1), (B2), (B3), (B4) or (B5) to form an integrated dual-cure coating material system, giving a total of 10 such systems.

### Example 2

### The Coating of Automobile Bodies with Multicoat Effect Paint Systems Comprising Clearcoat Systems Produced Using the Integrated Dual-Cure Coating Material Systems

### General Experimental Instructions

For the internal painting of automobile bodies beneath the trunk lid and the engine hood and in the area of the doorsills, trunk and insides of the doors and windows the dual-cure coating materials (B1) to (B5) were prepared shortly before application from the above-described dual-cure multicomponent systems (B1) to (B5) (cf. Example 1, Table 2) by mixing the respective components (I) and (II) in the following (I)/(II) mixing ratios (% by weight): (B1): 100/111; (B2): 100/111; (B3): 100/91; (B4): 100/89; (B5): 100/89.

For the external paint systems of automobile bodies the dual-cure coating materials (A1) and (A2) were prepared shortly before application from the above-described dual-cure two-component systems (A1) and (A2) (cf. Example 1, Table 1) by mixing the respective components (I) and (II) in the following (I)/(ll) mixing ratios (% by weight): (A1): 100/67; (A2): 100/65.

Automobile bodies which have been coated with a conventional electrocoat and a conventional primer-surfacer coat were coated with a commercially customary aqueous basecoat material comprising aluminum effect pigments. The aqueous basecoat films were briefly flashed off at room temperature and dried at 80° C. for 10 minutes. The wet film thicknesses were chosen so as to give film thicknesses of 12 to 15 μm after drying and curing.

The aqueous basecoat film in the interior of five automobile bodies was coated wet on wet with one each of the dual-cure coating materials (B1) to (B5), and the aqueous basecoat film on the outside was coated wet on wet with the dual-cure coating material (A1). The wet film thicknesses of the clearcoat films were set so as to give film thicknesses of 40 to 45 μm after curing.

The aqueous basecoat film in the interior of five automobile bodies was coated wet on wet with one each of the dual-cure coating materials (B1) to (B5), and the aqueous basecoat film on the outside was coated wet on wet with the dual-cure coating material (A2). The wet film thicknesses of the clearcoat films were set so as to give film thicknesses of 40 to 45 μm after curing.

The aqueous basecoat films and clearcoat films of the 10 automobile bodies were predried jointly at room temperature for 5 minutes and at 80° C. for 10 minutes, exposed to a UV radiation dose of 1500 mJ/cm² and subsequently cured at 140° C. for 20 minutes.

The resulting internal paint systems (B) were hard and scratch-resistant, allowing installation of the further components of the automobile without any problems. The resulting external paint systems (A) were highly scratch-resistant and hard. Both paint systems had outstanding optical properties and very high light stability and chemical, water, condensation, weather and etch resistance. Their capacity for overcoating was outstanding. In particular, however, there were no longer any paint defects in the areas where the internal (B) and external (A) paint systems overlapped.

1. An integrated dual-cure coating material system comprising:
at least one dual-cure multicomponent systems (A) and
at least one dual-cure multicomponent system (B),
wherein the dual-cure multicomponent systems (A) and (B) are composed predominantly or wholly of the same constituents and comprise in each case at least a first components (I) and a second component (II) stored separately from one another,
wherein the first component (I) comprises
(i.1) isocyanate-reactive functional groups, and
(i.2) reactive functional groups comprising at least one bond which can be activated with actinic radiation, and
at least one of
(i.3) flexibilizing structural units, which when parts of a three dimensional networks lowers glass transition temperature Tg, of the three dimensional network,
(i.4) hardening structural units, which as part of a three-dimensional networks raises a glass transition temperature Tg of the three dimensional network, and mixtures thereof,
and the second component (II) comprises
(ii.1) free isocyanate groups,
(ii.2) reactive functional groups comprising at least one bond which can be activated with actinic radiation, and
at least one of (ii.3) flexibilizing structural units which as parts of a three-dimensional networks lowers a glass transition temperature Tg of the three dimensional network,
(ii.4) hardening structural units which as parts of a three-dimensional networks raises a glass transition temperature Tg of the three dimensional network, and mixtures thereof,
wherein the dual-cure multicomponent system (B) comprises at least one of (a)
a lower quantity of reactive functional groups containing at least one bond which can be activated with actinic radiation as compared to dual-cure multicomponent system (A), (b)
a higher quantity of hardening structural units as compared to dual-cure multicomponent system (A), or a mixture thereof.

2. The integrated dual-cure coating system of claim 1, comprising two dual-cure multicomponent systems (A) and (B).

3. The integrated dual-cure coating system of claim 1, comprising at least one dual-cure two-component system (A).

4. The integrated dual-cure coating system of claims 1, comprising at least one dual-cure two-component system (B).

5. The integrated dual-cure coating system of claim 1, wherein the dual-cure multicomponent systems (A) and (B) differ physically from one another in not more than two constituents.

6. The integrated dual-cure coating system of claim 1, wherein components (I) comprises at least one oligomeric and/or polymeric binder containing isocyanate reactive functional groups (i.1).

7. The integrated dual-cure coating system of claim 1, wherein components (I) comprises at least one low molecular mass and/or oligomeric constituent containing at least one reactive functional group.

8. The integrated dual-cure coating system of claim 1, wherein components (II) comprises at least one constituent comprising at least one free isocyanate group and at least one reactive functional group comprising at least one bond which can be activated with actinic radiation.

9. A method of internally and externally coating a three-dimensional substrates of complex shape, the method comprising applying the integrated dual coating system of claim 1 to the three-dimensional substrate of complex shape.

10. The method of claim 9, wherein the three-dimensional substrate is at least one surface of an automobile body.

11. A process for internally and externally coating a three-dimensional substrate of complex shape, the process comprising:
(1) preparing at least one dual-cure material (A) and at least one dual-cure coating material (B) by mixing in each case at least one component (I) and at least one component (II) together to provide a mixture, and homogenizing the resulting mixture,
(2) coating an outside of the three-dimensional substrate with the dual cure coating material (A) and an inside of the three-dimensional substrate with the dual-cure coating material (B), and
(3) curing the resulting coatings (A) and (B) thermally and with actinic radiation to give the integrated internal and external coating (B/A).
